(19) United States
(12) Patent Application Publication
(10) Pub. No.: US 2013/0154449 A1
(43) Pub. Date: Jun. 20, 2013

(54) Disk-shaped multi-combined three-dimensional permanent magnet motor

(71) Applicant: Kunyuan Shen, Suzhou (CN)

(72) Inventor: Kunyuan Shen, Suzhou (CN)

(21) Appl. No.: 13/689,275

(22) Filed: Nov. 29, 2012

(30) Foreign Application Priority Data
Dec. 16, 2011 (CN) 201110425896.4

(51) Int. Cl. H02K 21/24; H02K 11/00; H02K 16/00

(52) U.S. Cl. CPC H02K 21/24; H02K 16/00; H02K 11/0015
USPC 310/68 E; 310/156.32; 310/156.36

(57) ABSTRACT

A disk-shaped multi combined three-dimensional permanent magnet motor is provided. Two independent disk-shaped stators are respectively provided on a left side and a right side in a shell. A disk-shaped rotor with permanent magnets adhered on both a left face and a right face thereof is provided between the two independent disk-shaped stators. Spindle hole in the center of the rotor is coupled with a spindle of the main dynamical axis. Nine motor winding coils provided in side face slots of the disk-shaped stators are a unit for one motor. The left and right stators serve as one group to determine pole-pairs number of the motor which further determines numbers of the permanent magnets adhered. The motor is capable of driving load at low speed and meeting the function requirements of low-speed and high torque, which greatly improve efficiency of the whole machine.

### BACKGROUND OF THE PRESENT INVENTION

1. Field of Invention

The present invention relates to a disk-shaped multi-combined three-dimensional permanent magnet motor.

2. Description of Related Arts

Currently, conventional low-speed and high-torque column type permanent magnet motors only meet the function requirements in partial circumstances. In most functional application fields, motors still need a high voltage, and high speed of the motors is reduced to a required speed for outputting through a reduction gearbox, which causes that effective area of the motors can not be fully utilized, and the requirements of users for low-speed and high torque can not be met.

### SUMMARY OF THE PRESENT INVENTION

In view of situations that in conventional arts the conventional column type permanent magnet motors are insufficient to meet the demands in most circumstances, an object of the present invention is to provide a disk-shaped multi-combined three-dimensional permanent magnet motor which has advantages of simple structure, reliable operation, small size, light weight, low wastage, low voltage, high efficiency and etc.

In order to accomplish the above objects, technical solutions provided by the present invention are following.

A disk-shaped multi-combined three-dimensional permanent magnet motor, comprises: an upper shell, a lower shell, a front cover, a rear cover, a single-unit motor, a first rotor, a first stator, a double-unit motor, a second stator, a third stator, a second rotor and a main dynamical axis,
wherein the single-unit motor and the double-unit motor are respectively provided around the main dynamical axis,
the first rotor and the second rotor which are cooperated with each other are connected with the main dynamical axis by coupling with spindles thereof, and
a pulley, a first encoder and a second encoder respectively connected with an electronic control are provided on the main dynamical axis.

Preferably, the first stator, the second stator and the third stator comprise: a first stator magneto-resistance support, a second stator magneto-resistance support, a third stator magneto-resistance support, a first iron core, a second iron core, a third iron core, and a first motor stator winding coil, a second motor stator winding coil, a third motor stator winding coil, a fourth motor stator winding coil, a fifth motor stator winding coil, a sixth motor stator winding coil, a seventh motor stator winding coil, an eighth motor stator winding coil, and a ninth motor stator winding coil which wind on the first iron core, the second iron core and the third iron core.

Preferably, the first rotor and the second rotor comprise a first rotor magnetic conductive steel sheet, a second rotor magnetic conductive steel sheet, a third rotor magnetic conductive steel sheet, a first magnetic steel provided on the first rotor magnetic conductive steel sheet, a second magnetic steel provided on the second rotor magnetic conductive steel sheet, and a third magnetic steel provided on the third rotor magnetic conductive steel sheet.

Preferably, a first double row angular contact ball bearing, a second double row angular contact ball bearing, and a third double row angular contact ball bearing are provided in the single-unit motor and the double-unit motor.

Preferably, a first winding coil unit, a second winding coil unit and a third winding coil unit are respectively provided on the three iron cores, and three winding coil components are respectively provided on each of the three winding coil units.

Preferably, each of the three iron core is formed by winding silicon steel thin sheet from an inside out, a wire slot thereof is a U-shape slot having an inclination angle of 0-30°, the nine motor stator winding coils in unit are respectively winding the first iron core, the second iron core and the third iron core which are corresponded in three phases, in such a manner that wire coils of a unit is accomplished.

Preferably, pole-pairs numbers thereof are 3-20 pairs.

Preferably, non-uniform air-gaps are adopted in the disk-shaped multi-combined three-dimensional permanent magnet motor.

Beneficial effects of the present invention are following.

The disk-shaped multi-combined three-dimensional permanent magnet motor of the present invention completely changes structures of conventional motors, takes full advantage of a three-dimensional space of motors, has output characteristics of high-power density, is capable of meeting the requirements of the motors for electromechanical energy conversion, low-speed and high torque better. Further, the disk-shaped multi-combined three-dimensional permanent magnet motor is capable of driving load at low speed and meeting the function requirements of low-speed and high torque, which greatly improves efficiency of the whole machine.

### BRIEF DESCRIPTION OF THE DRAWINGS

FIG. 1 is an external sketch view of a disk-shaped multi-combined three-dimensional permanent magnet motor according to a preferred embodiment of the present invention.

FIG. 2 is a sectional view of the disk-shaped multi-combined three-dimensional permanent magnet motor according to the preferred embodiment of the present invention in the FIG. 1.

FIG. 3 is an exploded view of a whole motor of the disk-shaped multi-combined three-dimensional permanent magnet motor according to the preferred embodiment of the present invention in the FIG. 1.

FIG. 4 is an exploded view of a first direction of the disk-shaped multi-combined three-dimensional permanent magnet motor according to the preferred embodiment of the present invention in the FIG. 1.

FIG. 5 is an exploded view of a second direction of the disk-shaped multi-combined three-dimensional permanent magnet motor according to the preferred embodiment of the present invention in the FIG. 1.

FIG. 6 is a sketch view of winding coils of a single-unit motor in the disk-shaped multi-combined three-dimensional permanent magnet motor according to the preferred embodiment of the present invention in the FIG. 1.

### DETAILED DESCRIPTION OF THE PREFERRED EMBODIMENT

These and other objectives, features, and advantages of the present invention will become apparent from the following detailed description, the accompanying drawings, and the appended claims. One skilled in the art will understand that the direction words of the present invention, such as upper, lower, left, right, front and rear, as shown in the following preferred embodiment are exemplary only for referring the directions of the accompanying drawings. Therefore, applying of the direction words are for illustrating and not intended to be limiting the invention.

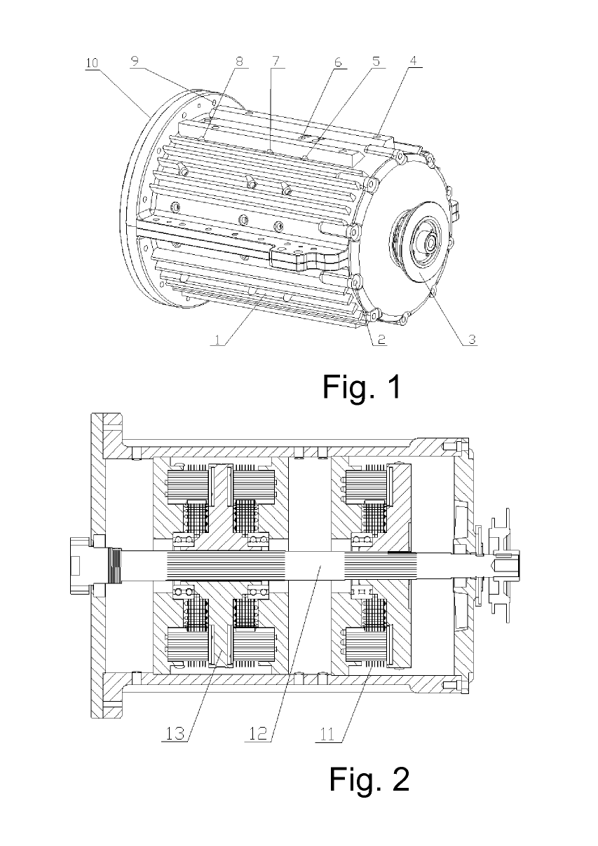

Referring to FIG. 1-3, a disk-shaped multi-combined three-dimensional permanent magnet motor 1 according to a first preferred embodiment of the present invention, comprises: an upper shell 17, a lower shell 18, a front cover 10, a rear cover 18, a single-unit motor 11, a first rotor 20, a first stator 23, a double-unit motor 13, a second stator 26, a third stator 31, a second rotor 28 and a main dynamical axis 12,
wherein the single-unit motor 11 and the double-unit motor 13 are respectively provided around the main dynamical axis 12,
the first rotor 20 of the disk-shaped multi-combined three-dimensional permanent magnet motor 1 and the second rotor 28 of the double-unit motor 13 which are cooperated with each other are connected with the main dynamical axis 12 by coupling with spindles thereof, and
a pulley 3 is provided on the main dynamical axis 12 for driving an automotive air condition, a first encoder 15 and a second encoder 16 respectively connected with an electronic control are also provided on the main dynamical axis for detecting and transmitting a speed signal.

A first screw 2, a second screw 4, a third screw 5, a fourth screw 7, a fifth screw 8 and a sixth screw 9 are provided on the shell for fixing the shell, the front cover, the rear cover and the frames of the stators.

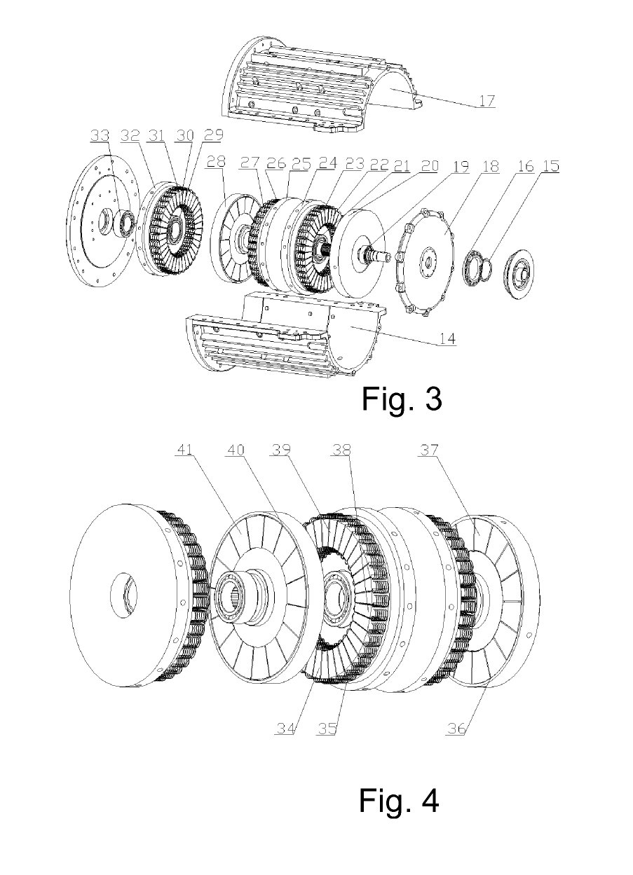

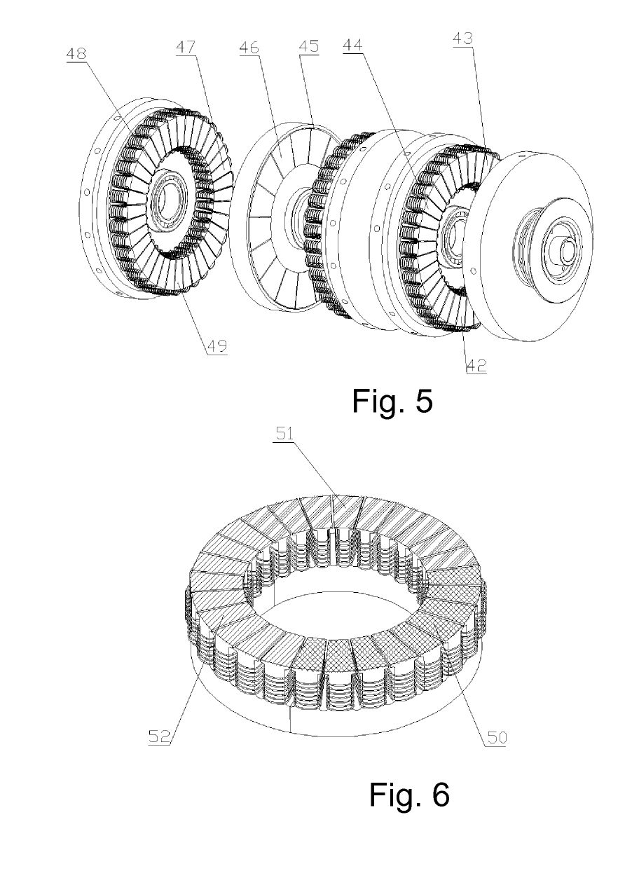

Referring to FIG. 3-5 of the drawings, the first stator 23, the second stator 26 and the third stator 31 comprise: a first stator magneto-resistance support 24, a second stator magneto-resistance support 25, a third stator magneto-resistance support 32, a first iron core 22, a second iron core 27, a third iron core 30, and a first motor stator winding coil 34, a second motor stator winding coil 35, a third motor stator winding coil 39, a fourth motor stator winding coil 42, a fifth motor stator winding coil 43, a sixth motor stator winding coil 44, a seventh motor stator winding coil 47, an eighth motor stator winding coil 48, and a ninth motor stator winding coil 49 which wind on the first iron core 22, the second iron core 27 and the third iron core 30.

The first rotor 20 and the second rotor 28 comprise a first rotor magnetic conductive steel sheet 36, a second rotor magnetic conductive steel sheet 40, a third rotor magnetic conductive steel sheet 45, a first magnetic steel 37 provided on the first rotor magnetic conductive steel sheet 36, a second magnetic steel 41 provided on the second rotor magnetic conductive steel sheet 40, and a third magnetic steel 46 provided on the third rotor magnetic conductive steel sheet 45.

A first double row angular contact ball bearing 21, a second double row angular contact ball bearing 29, and a third double row angular contact ball bearing 38 are provided in the single-unit motor 11 and the double-unit motor 13 for supporting a space between the stators and the rotors.

Referring to FIG. 6 of the drawings, a first winding coil unit 50, a second winding coil unit 51 and a third winding coil unit 52 are respectively provided on the three iron cores, and three winding coil components are provided on each of the three winding coil units, i.e., nine winding coil components are provided on the stator iron cores The nine winding coil components all function on a rotor, in such a manner that the rotor is capable of starting quickly.

According to another embodiment of the present invention, the first iron coil 22, the second iron coil 27, the third iron core 30 are all formed by winding silicon steel thin sheet from the inside out, a wire slot thereof is a U-shape slot having an inclination angle of 0-30°,

wherein the first motor stator winding coil 34, the second motor stator winding coil 35, the third motor stator winding coil 39, the fourth motor stator winding coil 42, the fifth motor stator winding coil 43, the sixth motor stator winding coil 44, the seventh motor stator winding coil 47, the eighth motor stator winding coil 48, and the ninth motor stator winding coil 49 are winding on side faces of the first iron coil 22, the second iron coil 27, and the third iron coil 30,

wherein the nine motor stator winding coils in unit respectively wind on the first iron core, the second iron core and the third iron core which are corresponded in three phases, in such a manner that wire coils of a unit is accomplished.

In other words, referring to FIG. 1-6, the present invention provides a combined motor, comprising:
an upper shell 17,
a lower shell 14,
a front cover 10,
a rear cover 18, wherein the upper shell 17, the lower shell 14, the front cover 10 and the rear cover 18 are connected with each other and form an inner space,
a main dynamical axis 12 provided in the inner space
a single-unit motor 11 provided around the main dynamical axis 12, and comprising a first stator 23 and a first rotor 20 which are cooperated with each other,
a double-unit motor 13 provided around the main dynamical axis 12, and comprising a second stator 26, a third stator 31 and a second rotor 28, wherein the second rotor 28 is connected with the main dynamical axis 12 and cooperated with the second stator 26 and the third stator 31,
a pulley 3 provided on the main dynamical axis 12, and
a first encoder 15 and a second encoder 16 provided on the main dynamical axis 12 which are respectively connected with an electronic control for detecting and transmitting a speed signal.

Preferably, the first stator 23 comprises a first stator magneto-resistance support 24, a first iron core 22, and a fourth stator winding coil 42, a fifth stator winding coil 43 and a sixth stator winding coil 46 which wind on the first iron core;
the second stator 26 comprises a second stator magneto-resistance support 25, a second iron core 27, and a first stator winding coil 34, a second stator winding coil 35 and a third stator winding coil 39 which wind on the second iron core 27;
the third stator 31 comprises a third stator magneto-resistance support 32, a third iron core 30, and a seventh stator winding coil 47, an eighth stator winding coil 48 and a nine stator winding coil 49 which wind on the third iron core 30.

Preferably, the first rotor 20 comprises a first rotor magnetic conductive steel sheet 36, and a first magnetic steel 37 provided on the first rotor magnetic conductive steel sheet 36,
the second rotor 28 comprises a second rotor magnetic conductive steel sheet 40, a third rotor magnetic conductive steel sheet 45, a second magnetic steel 41 provided on the second rotor magnetic conductive steel sheet 40, and a third magnetic steel 46 provided on the third rotor magnetic conductive steel sheet 45, wherein the second rotor magnetic conductive steel sheet 40 and the third rotor magnetic conductive steel sheet 45 are oppositely provided, and respectively coupling with the second stator 26 and the third stator 31.

Preferably, a first double row angular contact ball bearing 21 is provided in the single-unit motor 11, a second double row angular contact ball bearing 29, and a third double row angular contact ball bearing 38 are provided in the double-unit motor 13, so as to support a space between the stators and the rotors.

Preferably, each of the first motor stator winding coil 34, the second motor stator winding coil 35, the third motor stator winding coil 39, the fourth motor stator winding coil 42, the fifth motor stator winding coil 43, the sixth motor stator winding coil 44, the seventh motor stator winding coil 47, the eighth motor stator winding coil 48, and the ninth motor stator winding coil 49 comprises three winding coil units, i.e., nine winding coil units are provided on each of the first iron core 22, the second iron core 27 and the third iron core 30, and the nine winding coil units all interacts on one rotor, in such a manner that the rotor is capable of starting quickly in a short time.

Preferably, each of the first iron core 22, the second iron core 27 and the third iron core 30 is formed by winding silicon steel thin sheet from the inside out, a wire slot thereof is a U-shape slot having an inclination angle of 0-30°.

Preferably, pole-pairs numbers of the combined motor are 3-20 pairs.

Preferably, non-uniform air-gaps are adopted in the combined motor.

### Effects of Implementation and Application

Compared with a conventional column type permanent magnet motor, advantages of the present invention disk-shaped multi-combined three-dimensional permanent magnet motor are following.

When applied to a city public bus, the conventional column type permanent magnet motor requires a voltage of over 600V; however the disk-shaped multi-combined three-dimensional permanent magnet motor requires a voltage of only 300V.

When applied to a compact car, the conventional column type permanent magnet motor requires a voltage of over 360V; however the disk-shaped multi-combined three-dimensional permanent magnet motor requires a voltage of only 115V.

Taking a city public bus of 10 meters as an example for calculating, a highest torque thereof is 460 Nm, and in order to output the 460 Nm torque required, the conventional column type permanent magnet motor should be under a voltage of 600V and a power of 200 KW. Electric current that the conventional column type permanent magnet motor requires at the highest torque output is 2.5 times as thereof the constant-speed torque output, e.g., the electric current output under 200 KW/600V and at the constant-speed torque is 400 A, while the electric current output at the highest torque is 1000 A. Therefore, the voltage of 600V is for protecting excessive doubled heavy-current release. Thus, in order to meet function requirements mentioned above, volume of a motor body should be about 1 m×1.5 m. And a huge volume of a whole motor requires adjusting structures greatly in function matching, which increases manufacture cost for a whole function significantly. Further, when applied in cities, high power of over 600V requires constructing a large number of high voltage generating station for matching, which greatly enhances investment of the entire projects as well.

The disk-shaped multi-combined three-dimensional permanent magnet consists of one and a half combinations, i.e., three disk-shaped stators, a double-sided rotor and a one-sided rotor. Three motor winding coil components are adopted in each motor disk-shaped stator unit. Output power of one motor winding coil component is 10 KW, and for 9 motor winding coil components (1×3×3=9), total output power is 90 KW. Output torque of each motor unit is 200 Nm, and for three motor units, total output torque is 200×3=600 Nm. Under 10 KW/300V, each of the motor winding coil components requires an electric current of 33 A, and electric current of the whole motor required is 33×3×3=99 A×3=300 A.

Application of high power is for improving efficiency ratio of the motor.

Adopting the voltage of 600V in conventional column type permanent magnet motors is aimed for the power of 200 KW of the whole motor.

Adopting the voltage of 300V in the disk-shaped multi-combined three-dimensional permanent motor is aimed for nine 10 KW-powers, and the power of the whole motor is 90 KW. A ratio of the 300V adopted in the disk-shaped multi-combined three-dimensional permanent motor to a voltage adopted in conventional column type permanent magnet motors is over 10:1. Torque in a low-speed starting and high-torque output is twice as thereof the conventional column type permanent magnet motors.

The whole device is capable of starting only when electric current of the conventional column type permanent magnet motor is 2.5 times as electric current under rated power of the whole motor.

The disk-shaped multi-combined three-dimensional permanent magnet motor is capable of starting the whole device quickly in a short time when electric current thereof is improved by 20% on a basis of an electric current required under a rated power, which shortens discharge time of heavy electric current when starting and speeding up the device. Especially when the device reaches a certain speed, electric current of one motor group (one motor unit and three winding coil components) is turned off automatically by a controller, in such a manner that power and energy of the whole motor is applied more reasonably, in such a manner that each of the motor unit is ensured to be at a highest efficient point of working conditions. E.g., when the three motor units are operating at a highest efficient point of working conditions, electric current of the whole motor is 99 A×3=300 A. However, when one motor unit is turned off, the electric current thereof is only 200 A, which can not be achieved by conventional column type permanent magnet motors. Under a same voltage and a same 200 A electric current, output power and output torque of the disk-shaped multi-combined three-dimensional permanent magnet is over two times of a conventional column type permanent magnet motor.

The disk-shaped multi-combined three-dimensional permanent magnet motor does not have excitation loss, has high efficiency, high power factor, high power density, small volume. Furthermore, coupling with a vector variable frequency speed regulation controller, the disk-shaped multi-combined three-dimensional permanent magnet motor contributes to pioneering innovation in era proposition of high efficiency and energy conservation.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A disk-shaped multi-combined three-dimensional permanent magnet motor, comprising: an upper shell, a lower shell, a front cover, a rear cover, a single-unit motor, a first rotor, a first stator, a double-unit motor, a second stator, a third stator, a second rotor and a main dynamical axis,
wherein said single-unit motor and said double-unit motor are respectively provided around said main dynamical axis,
said first rotor and said second rotor which are cooperated with each other are connected with said main dynamical axis by coupling with spindles thereof, and
a pulley, a first encoder and a second encoder respectively connected with an electronic control are provided on said main dynamical axis.

2. The disk-shaped multi-combined three-dimensional permanent magnet motor, as recited in claim 1, wherein said first stator, said second stator and said third stator comprise: a first stator magneto-resistance support, a second stator magneto-resistance support, a third stator magneto-resistance support, a first iron core, a second iron core, a third iron core, and a first motor stator winding coil, a second motor stator winding coil, a third motor stator winding coil, a fourth motor stator winding coil, a fifth motor stator winding coil, a sixth motor stator winding coil, a seventh motor stator winding coil, an eighth motor stator winding coil, and a ninth motor stator winding coil which wind on said first iron core, said second iron core and said third iron core.

3. The disk-shaped multi-combined three-dimensional permanent magnet motor, as recited in claim 1, wherein said first rotor and said second rotor comprise a first rotor magnetic conductive steel sheet, a second rotor magnetic conductive steel sheet, a third rotor magnetic conductive steel sheet, a first magnetic steel provided on said first rotor magnetic conductive steel sheet, a second magnetic steel provided on said second rotor magnetic conductive steel sheet, and a third magnetic steel provided on said third rotor magnetic conductive steel sheet.

4. The disk-shaped multi-combined three-dimensional permanent magnet motor, as recited in claim 1, wherein a first double row angular contact ball bearing, a second double row angular contact ball bearing, and a third double row angular contact ball bearing are provided in said single-unit motor and said double-unit motor.

5. The disk-shaped multi-combined three-dimensional permanent magnet motor, as recited in claim 2, wherein a first winding coil unit, a second winding coil unit and a third winding coil unit are respectively provided on said three iron cores, and three winding coil components are respectively provided on each of said three winding coil units.

6. The disk-shaped multi-combined three-dimensional permanent magnet motor, as recited in claim 2, wherein each of said three iron core is formed by winding silicon steel thin sheet from an inside out, a wire slot thereof is a U-shape slot having an inclination angle of 0-30°, said nine motor stator winding coils in unit are respectively winded said first iron core, said second iron core and said third iron core which are corresponded in three phases, in such a manner that wire coils of a unit is accomplished.

7. The disk-shaped multi-combined three-dimensional permanent magnet motor, as recited in claim 1, wherein pole-pairs numbers thereof are 3-20 pairs.

8. The disk-shaped multi-combined three-dimensional permanent magnet motor, as recited in claim 1, wherein non-uniform air-gaps are adopted in said disk-shaped multi-combined three-dimensional permanent magnet motor.

9. A combined motor, comprising:
an upper shell,
a lower shell,
a front cover,
a rear cover, wherein said upper shell, said lower shell, said front cover and said rear cover are connected with each other and form an inner space,
a main dynamical axis provided in said inner space,
a single-unit motor provided around said main dynamical axis, and comprising a first stator and a first rotor which are cooperated with each other,
a double-unit motor provided around said main dynamical axis, and comprising a second stator, a third stator and a second rotor, wherein said second rotor is connected with said main dynamical axis and cooperated with said second stator and said third stator,
a pulley provided on said main dynamical axis, and
a first encoder and a second encoder provided on said main dynamical axis which are respectively connected with an electronic control for detecting and transmitting a speed signal.

10. The combined motor, as recited in claim 9, wherein
said first stator comprises a first stator magneto-resistance support, a first iron core, and a fourth stator winding coil, a fifth stator winding coil and a sixth stator winding coil which wind on said first iron core;
said second stator comprises a second stator magneto-resistance support, a second iron core, and a first stator winding coil, a second stator winding coil and a third stator winding coil which wind on said second iron core;
said third stator comprises a third stator magneto-resistance support, a third iron core, and a seventh stator winding coil, an eighth stator winding coil and a nine stator winding coil which wind on said third iron core.

11. The combined motor, as recited in claim 9, wherein:
said first rotor comprises a first rotor magnetic conductive steel sheet, and a first magnetic steel provided on said first rotor magnetic conductive steel sheet,
said second rotor comprises a second rotor magnetic conductive steel sheet, a third rotor magnetic conductive steel sheet, a second magnetic steel provided on said second rotor magnetic conductive steel sheet, and a third magnetic steel provided on said third rotor magnetic conductive steel sheet, wherein said second rotor magnetic conductive steel sheet and said third rotor magnetic conductive steel sheet are oppositely provided, and respectively coupling with said second stator and said third stator.

12. The combined motor, as recited in claim 10, wherein:
said first rotor comprises a first rotor magnetic conductive steel sheet, and a first magnetic steel provided on said first rotor magnetic conductive steel sheet,
said second rotor comprises a second rotor magnetic conductive steel sheet, a third rotor magnetic conductive steel sheet, a second magnetic steel provided on said second rotor magnetic conductive steel sheet, and a third magnetic steel provided on said third rotor magnetic conductive steel sheet, wherein said second rotor magnetic conductive steel sheet and said third rotor magnetic conductive steel sheet are oppositely provided, and respectively coupling with said second stator and said third stator.

13. The combined motor, as recited in claim 9, wherein a first double row angular contact ball bearing is provided in said single-unit motor, a second double row angular contact ball bearing, and a third double row angular contact ball bearing are provided in said double-unit motor, so as to support a space between said stators and said rotors.

14. The combined motor, as recited in claim 12, wherein a first double row angular contact ball bearing is provided in said single-unit motor, a second double row angular contact ball bearing, and a third double row angular contact ball bearing are provided in said double-unit motor, so as to support a space between said stators and said rotors.

15. The combined motor, as recited in claim 10, wherein each of said first motor stator winding coil, said second motor stator winding coil, said third motor stator winding coil, said fourth motor stator winding coil, said fifth motor stator winding coil, said sixth motor stator winding coil, said seventh motor stator winding coil, said eighth motor stator winding coil, and said ninth motor stator winding coil comprises three winding coil units, i.e., nine winding coil units are provided on each of said first iron core, said second iron core and said third iron core, and said nine winding coil units all interacts on one rotor, in such a manner that said rotor is capable of starting quickly in a short time.

16. The combined motor, as recited in claim 14, wherein each of said first motor stator winding coil, said second motor stator winding coil, said third motor stator winding coil, said fourth motor stator winding coil, said fifth motor stator winding coil, said sixth motor stator winding coil, said seventh motor stator winding coil, said eighth motor stator winding coil, and said ninth motor stator winding coil comprises three winding coil units, i.e., nine winding coil units are provided on each of said first iron core, said second iron core and said third iron core, and said nine winding coil units all interacts on one rotor, in such a manner that said rotor is capable of starting quickly in a short time.

17. The combined motor, as recited in claim 10, wherein each of said first iron core, said second iron core and said third iron core is formed by winding silicon steel thin sheet from the inside out, a wire slot thereof is a U-shape slot having an inclination angle of 0-30°.

18. The combined motor, as recited in claim 16, wherein each of said first iron core, said second iron core and said third iron core is formed by winding silicon steel thin sheet from the inside out, a wire slot thereof is a U-shape slot having an inclination angle of 0-30°.

19. The combined motor, as recited in claim 9, wherein pole-pairs numbers thereof are 3-20 pairs.

20. The combined motor, as recited in claim 9, wherein non-uniform air-gaps are adopted in said combined motor.
